(19) United States
(12) Patent Application Publication
(10) Pub. No.: US 2014/0120959 A1
(43) Pub. Date: May 1, 2014

(54) ADJUST PAGING INDICATOR CHANNEL DETECTION THRESHOLD DEPENDING ON REMAINING BATTERY LEVEL

(71) Applicant: QUALCOMM INCORPORATED, San Diego, CA (US)

(72) Inventors: Insung Kang, San Diego, CA (US); Qingxin Chen, Del Mar, CA (US); Tom Chin, San Diego, CA (US); Ming Yang, San Diego, CA (US)

(73) Assignee: QUALCOMM Incorporated, San Diego, CA (US)

(21) Appl. No.: 13/664,672

(22) Filed: Oct. 31, 2012

(51) Int. Cl. H04W 68/00

(52) U.S. Cl. 455/458

(57) ABSTRACT

A user equipment may save power and improve performance by adjusting a paging indicator detection threshold of power at which a user equipment (UE) determines a paging indicator channel transmission is received when detecting a signal on a paging indicator channel. The adjustment may be based on the UE's remaining battery power. When the battery power level is low, the threshold is increased to reduce false detections. When the battery power level is high, the threshold is decreased to increase the likelihood of detecting the signal on a paging indicator channel.

### BACKGROUND

1. Field

Aspects of the present disclosure relate generally to wireless communication systems, and more particularly, to adjusting a paging indicator channel detection threshold depending on remaining battery level.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining a remaining battery power level of a user equipment. The method may also include setting a paging indicator detection threshold based at least in part on the determining and on a function of a standard deviation of a paging indicator channel (PICH) signal strength.

According to another aspect of the present disclosure, an apparatus for wireless communication includes means for determining a remaining battery power level of a user equipment. The apparatus may also include means for setting a paging indicator detection threshold based at least in part on the determining and on a function of a standard deviation of a paging indicator channel (PICH) signal strength.

According to one aspect of the present disclosure, a computer program product for wireless communication in a wireless network includes a computer readable medium having non-transitory program code recorded thereon. The program code includes program code to determine a remaining battery power level of a user equipment. The program code also includes program code to set a paging indicator detection threshold based at least in part on the determining and on a function of a standard deviation of a paging indicator channel (PICH) signal strength.

According to one aspect of the present disclosure, an apparatus for wireless communication includes a memory and a processor(s) coupled to the memory. The processor(s) is configured to determine a remaining battery power level of a user equipment. The processor(s) is further configured to set a paging indicator detection threshold based at least in part on the determining and on a function of a standard deviation of a paging indicator channel (PICH) signal strength.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE 350 in a telecommunications system.

FIG. 4 illustrates a geographical area with coverage from three radio access technologies according to one aspect of the present disclosure.

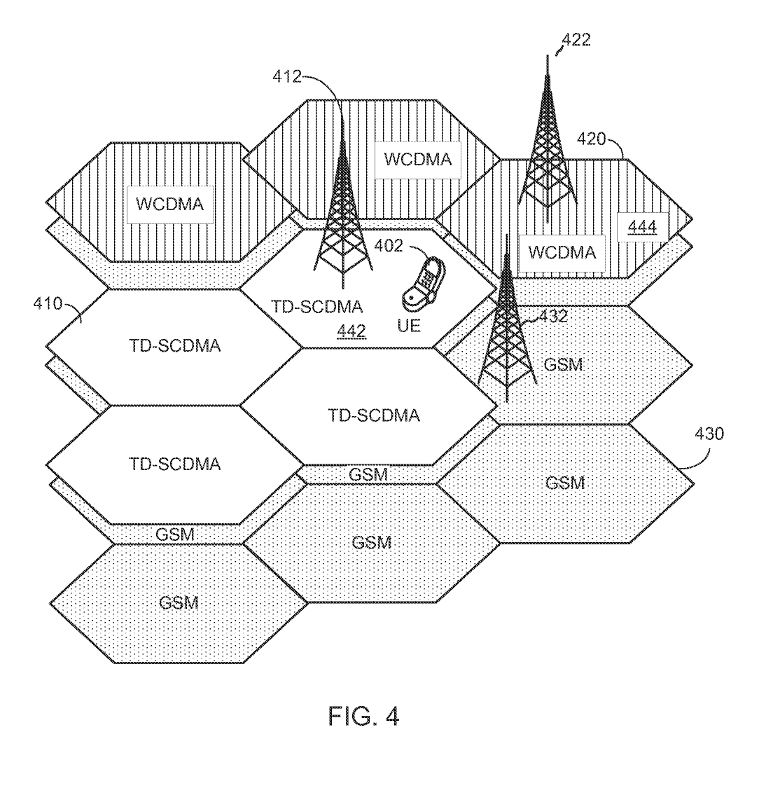

FIG. 5 is a block diagram conceptually illustrating an example of a structure of Paging Indicator Channel (PICH) and Paging Channel (PCH).

FIG. 6 illustrates a normal distribution graph of the remaining battery level with respect to the paging indicator signal.

FIG. 7 is a block diagram of a method for adjusting a paging indicator channel detection threshold depending on remaining battery level according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

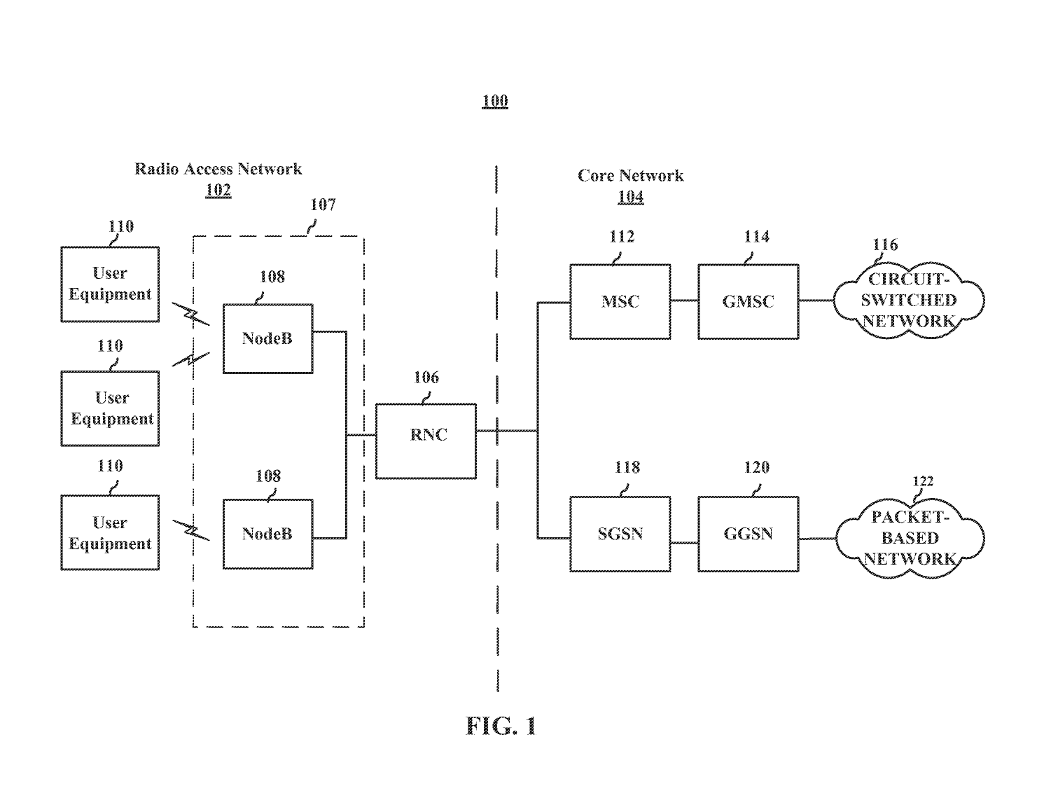

Turning now to FIG. 1, a block diagram is shown illustrating an example of a telecommunications system 90. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

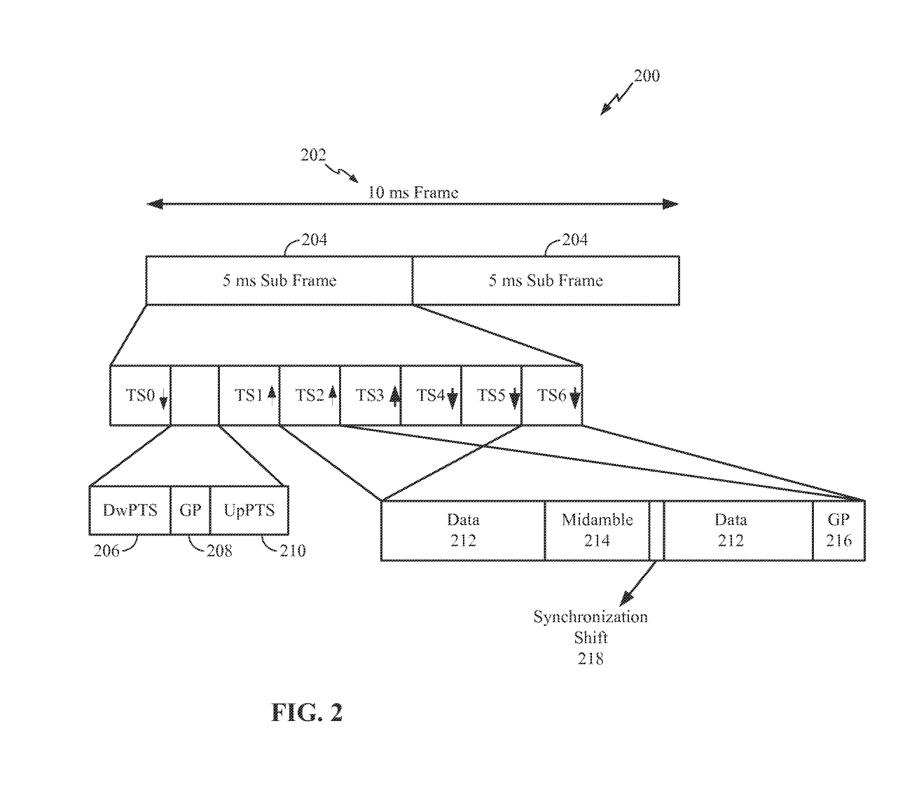

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

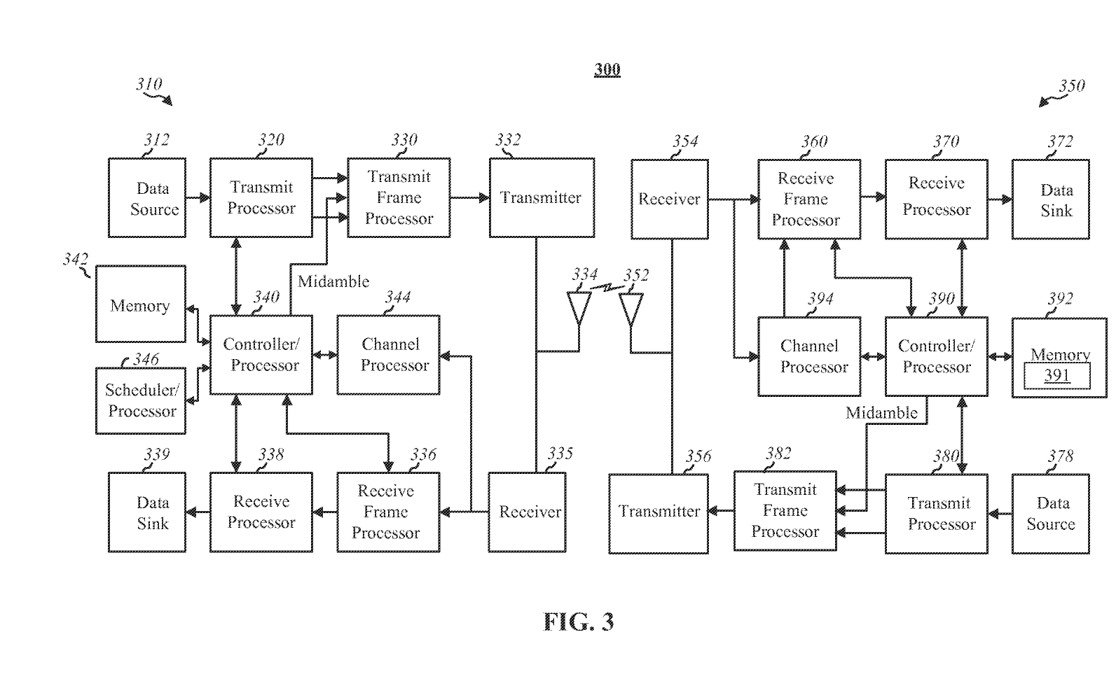

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

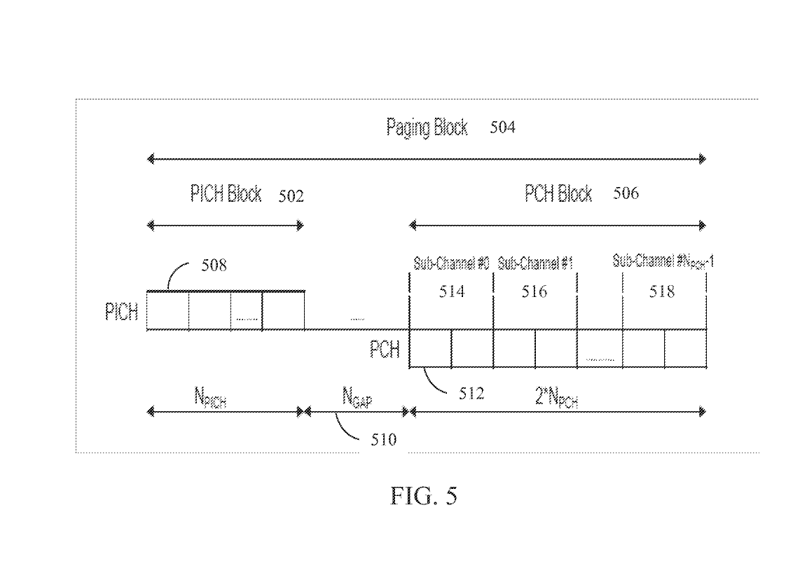

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The processor 340/390 and/or other processors and modules at the node B 310/UE 350 may perform or direct the execution of the functional blocks illustrated in FIG. 5. The computer readable media of memories 342 and 392 may store data and software for the node B 310 and the UE 350, respectively. For example, the memory 392 of the UE 350 may store a channel detection threshold adjustment module 391 which, when executed by the controller/processor 390, configures the UE 350 for building high speed shared information control channels (HS-SICHS) in multi-carrier time division high speed downlink packet access (HSDPA) systems as described. A scheduler/processor 346 at the node B 310 may be used to allocate resources to the UEs and schedule downlink and/or uplink transmissions for the UEs.

### Adjust Paging Indicator Channel Detection Threshold Depending on Remaining Battery Level

During wireless communication, a user equipment (UE) may be sporadically active and may remain idle for significant periods of time when no call is in progress. In the idle state, UE circuitry may be powered down to conserve power. To ensure that any message directed to the UE is received, however, the UE may periodically monitor communication channels for messages (e.g., paging indicator messages or other signals transmitted by a base station), even while the UE is idle. The messages may include those for alerting the UE to the presence of an incoming call, those for updating system parameters in the UE, and/or instructions for measuring signals of radio access technologies (RAT) of neighboring base stations (i.e., inter-RAT measurements).

To reduce power consumption in a UE operating in idle mode, the UE may periodically enter an active state during which it may receive messages on a paging channel from the base stations with which it has previously established communication. The paging channel may be divided into numbered frames (e.g., frames 0 through 1023) and the UE may be assigned one or more frames by the base stations. Thereafter, the UE may awaken from an inactive state prior to its assigned frame, monitor the paging channels for messages, and revert to the inactive state if additional communication is not desired. Thus, the UE monitors paging messages from the base station informing the UE of possible incoming transmissions. In the time period between successive active states, the UE is in the inactive state and the base station does not send any messages to the UE.

In communication networks, (such as TD-SCDMA networks) to reduce power consumption in an idle mode, a UE may use discontinuous reception (DRX) to monitor for paging messages at recurring paging intervals. The time between two consecutive paging message is called a discontinuous receive (DRX) period or cycle. The UE monitors the paging occasion during the DRX cycle on the Paging Indicator Channel (PICH) and the Paging Channel (PCH).

FIG. 5 is a block diagram illustrating an example of a structure of a paging indicator channel (PICH) and a paging channel (PCH). A paging block 504 includes a PICH block 502, a PCH block 506 and a gap frame 510. The PICH block 502 may include PICH frames 508. The PCH block may include PCH frames 512 that are combined into sub-channels, e.g., sub-channels 514, 516, 518. The PICH block 502 may include N_{PICH} frames and the PCH block 506 may include 2× N_{PCH} frames as illustrated in FIG. 5. There may be N_{GAP} frames from the end of the PICH frames to the beginning of the PCH frames. The UE may be assigned to one of the N_{PICH} frames in the PICH block 502 and to one of N_{PCH} paging groups in the PCH block 506, which may start from an associated paging occasion. The parameters N_{PICH}, N_{GAP}, N_{PCH} may be known from a system information message.

A paging indicator in a PICH block may be set to a logic ‘1’, for example, to indicate that UEs associated with this paging indicator may read their corresponding paging sub-channel within the same paging block. When a UE detects a threshold power level or a paging indicator detection threshold on the PICH block 502, the UE interprets that block as the logic ‘1’. The power level threshold may be adjusted up or down depending on the power level the UE sets to recognize as a logic “1” on the PICH. The higher the power level threshold, the less likely that the UE will recognize all PICH transmissions, but also the less likely the UE will recognize false detections, which can be a drain on battery resources. The lower the power level threshold, the more likely battery power will be wasted on a false detection, but the less likely that a legitimate PICH transmission may be missed. Because the PICH indicator signal or paging signal on a PICH is not coded, detection of PICH indicators may be subject to false detection or false alarm.

False detection may be addressed by adjusting a threshold of power at which a UE determines a PICH transmission is received based on the UE's remaining battery power when detecting the signal on the paging indicator channel (PICH). The threshold may be referred to as a paging indicator detection threshold or PICH detection threshold. When the remaining battery power is low, the PICH detection threshold may be increased so that false detections, which result in wasted battery resources, are less common. When the remaining battery power is high, the threshold decreases so that the likelihood of detection increases.

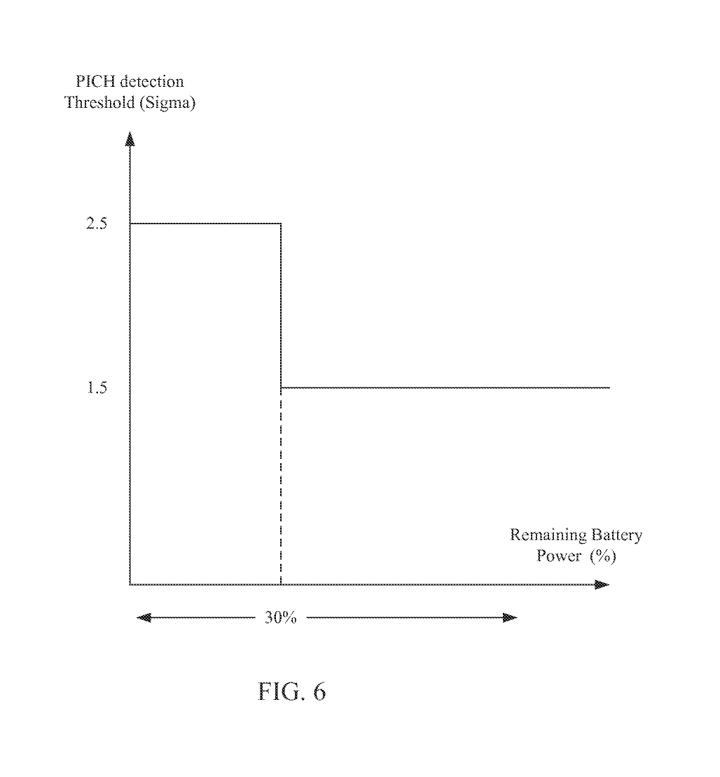

In one aspect of the disclosure, the PICH detection threshold may be adjusted based on a sampling of the remaining battery power level. For example, the energy or battery power level can be sampled according to a normal distribution or Gaussian distribution. FIG. 6 illustrates a normal distribution graph of the remaining battery level with respect to the paging indicator signal. The x-axis of the graph corresponds to the remaining battery level percent and the y-axis represents PICH detection threshold as a function of a standard deviation or sigma (σ) of the paging indicator signal. In FIG. 6, the PICH detection threshold is set at a standard deviation of 1.5 or a standard deviation of 2.5 of the PICH signal strength, depending on the percentage of the remaining battery power level. When the paging indicator signal is received, it is determined whether the paging indicator signal is a logic “1” or a “0” based on the paging indicator signal power level. The probability of a logic “1” or a “0” is based on the PICH detection threshold changes, which is based on the standard deviation. The standard deviation may be selected based on the remaining battery power level. For example, the standard deviation of 2.5 may be selected when the percentage of remaining battery power level is less than or equal to 30% and the standard deviation of 1.5 may be selected when the percentage of remaining battery power level is more than 30%. When the standard deviation is 2.5, there is a lower probability of the paging indicator signal being above the PICH detection threshold. As a result, the probability of false detections that waste battery resources is reduced. When the standard deviation is 1.5, the probability of the paging indicator signal being above the PICH detection threshold increases. As a result, there is an increase in the likelihood of detection of the paging indicator signal as well as an increases in the probability of false detection.

False PICH detection may cause a UE to stay awake longer to decode paging message on the PCH channel, which leads to wasted battery power and reduction in the UE standby time. The trade-off between detection probability and power consumption is described as follows: Assume that the detection metric is normalized such that it has a constant noise variance. Also, assume that the noise is Gaussian. Then a threshold for low battery power can be 2.5*sigma which results in 0.6% false detection. A threshold for high battery power can be 1.5*sigma which results in 6.7% false detection. In additive white Gaussian noise (AWGN), a signal to noise ratio of 10 dB results in a detection probability of 74.6% for 2.5*sigma and 95.2% for 1.5*sigma. Assume power consumption of PICH detection is 100 mA*ms (milliamps*milliseconds) and PCH decoding or detection is 1000 mA*ms. When there is no paging, the battery power consumed is given by 0.006*1000 mA*ms+100 mA*ms=106 mA*ms with 2.5*sigma. With 1.5*sigma, the battery power consumed is given by 0.067*1000 mA*ms+100 mA*ms=167 mA*ms. As a result, the power saving corresponds to 61 mA*ms. This implementation may result in power savings of about 20% of power associated with paging detection. If the signal to noise ratio (SNR) is higher, the detection loss is reduced. For an example, an SNR=15 dB may correspond to a detection probability of 99.9% and 100% with 2.5*sigma and 1.5*sigma.

In one aspect of the present disclosure, the remaining battery power may be mapped to the PICH detection threshold in a PICH detection table. For, example, Table 1 below shows a relationship of remaining battery power mapped to PICH detection thresholds. In one aspect of the disclosure, the UE checks the battery level at each wake up time and applies the PICH detection threshold accordingly. The mapped relationship can be programmed in the UE as a look-up table or dynamically computed using a software code or algorithm. The PICH detection thresholds and the remaining battery power may be implemented in various combinations to vary the adjustment of the PICH detection thresholds when the battery is low as illustrated in Table 1. The remaining battery level percentages may be predetermined percentage values.

TABLE 1

| Remaining | PICH Detection or Decoding |
|---|---|
| Battery Level (%) | Thresholds (Sigma) |
| 30% | 2.5 |
| 50% | 2 |
| 70% | 1.5 |
| 90% | 1 |

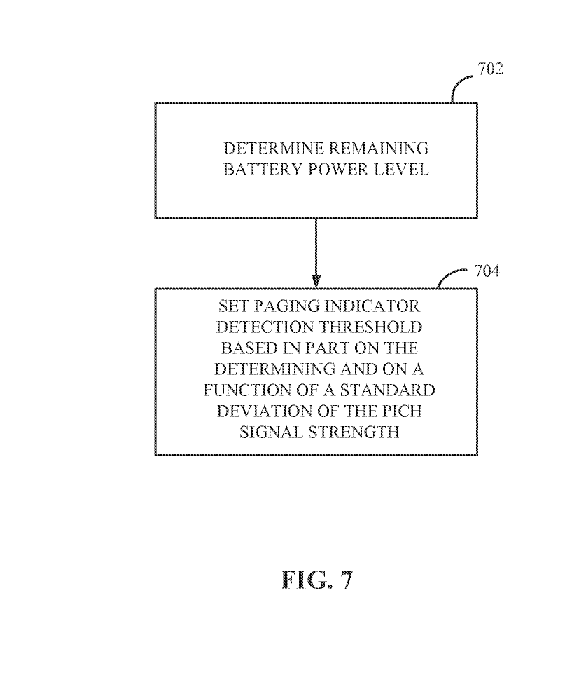

FIG. 7 is a block diagram of a method for adjusting a paging indicator channel detection threshold depending on remaining battery power level according to one aspect of the present disclosure. As shown in FIG. 7 a UE 350 may determine a remaining battery power level of the UE 350, as shown in block 702. The UE may set a paging indicator detection threshold based at least in part on the determining and on a function of a standard deviation of PICH signal strength, as shown in block 704.

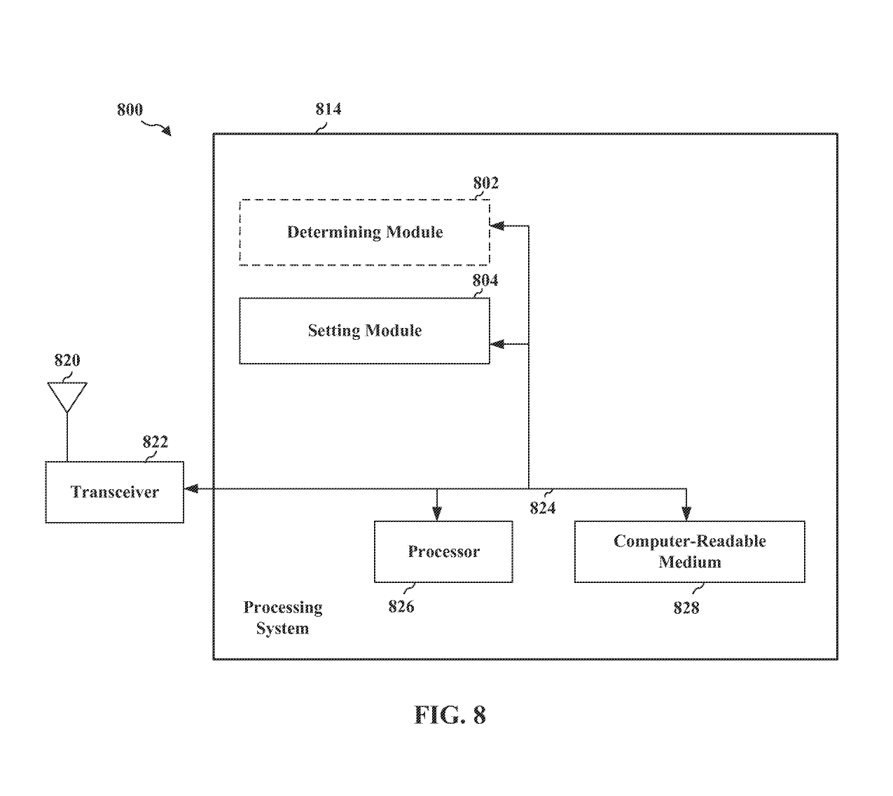

FIG. 8 is a diagram illustrating an example of a hardware implementation for an apparatus 800 employing a channel detection threshold adjustment system 814. The channel detection threshold adjustment system 814 may be implemented with a bus architecture, represented generally by the bus 824. The bus 824 may include any number of interconnecting buses and bridges depending on the specific application of the channel detection threshold adjustment system 814 and the overall design constraints. The bus 824 links together various circuits including one or more processors and/or hardware modules, represented by the processor 826, the modules 802, 804 and the computer-readable medium 828. The bus 824 may also link various other circuits such as timing sources, peripherals, voltage regulators, and power management circuits, which are well known in the art, and therefore, will not be described any further.

The apparatus includes the channel detection threshold adjustment system 814 coupled to a transceiver 822. The transceiver 822 is coupled to one or more antennas 820. The transceiver 822 enables communicating with various other apparatus over a transmission medium. The channel detection threshold adjustment system 814 includes a processor 826 coupled to a computer-readable medium 828. The processor 826 is responsible for general processing, including the execution of software stored on the computer-readable medium 828. The software, when executed by the processor 826, causes the channel detection threshold adjustment system 814 to perform the various functions described for any particular apparatus. The computer-readable medium 828 may also be used for storing data that is manipulated by the processor 826 when executing software.

The channel detection threshold adjustment system 814 includes a determining module 802 for determining a remaining battery power level of a user equipment. The channel detection threshold adjustment system 814 includes a setting module 804 for setting a paging indicator detection threshold based at least in part on the determining and on a function of a standard deviation of a paging indicator channel (PICH) signal strength. The modules may be software modules running in the processor 826, resident/stored in the computer-readable medium 828, one or more hardware modules coupled to the processor 826, or some combination thereof. The channel detection threshold adjustment system 814 may be a component of the UE 350 and may include the memory 392, and/or the controller/processor 390.

In one configuration, an apparatus such as a UE is configured for wireless communication including means for determining and means for setting. In one aspect, the above means may be the antennas 352, the receiver 354, the channel processor 394, the receive frame processor 360, the receive processor 370, the transmitter 356, the transmit frame processor 382, the transmit processor 380, the controller/processor 390, the memory 392, the channel detection threshold adjustment module 391, determining module 802, setting module 804 and/or the a channel detection threshold adjustment system 814 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining a remaining battery power level of a user equipment; and
setting a paging indicator detection threshold based at least in part on the determining and on a function of a standard deviation of a paging indicator channel (PICH) signal strength.

2. The method of claim 1, in which the paging indicator detection threshold is a threshold of received power for a received transmission on a PICH.

3. The method of claim 1, further comprising mapping remaining battery power levels to PICH detection thresholds to set the paging indicator detection threshold.

4. The method of claim 1, in which the paging indicator detection threshold is raised when the remaining battery power level is below a power threshold.

5. The method of claim 1, in which the paging indicator detection threshold is lowered when the remaining battery power level is above a power threshold.

6. An apparatus for wireless communication, comprising:
means for determining a remaining battery power level of a user equipment; and
means for setting a paging indicator detection threshold based at least in part on the determining and on a function of a standard deviation of a paging indicator channel (PICH) signal strength.

7. The apparatus of claim 6, in which the paging indicator detection threshold is a threshold of received power for a received transmission on a PICH.

8. The apparatus of claim 6, further comprising means for mapping remaining battery power levels to PICH detection thresholds to set the paging indicator detection threshold.

9. The apparatus of claim 6, further comprising means for raising the paging indicator detection threshold when the remaining battery power level is below a power threshold.

10. The apparatus of claim 6, further comprising means for lowering the paging indicator detection threshold when the remaining battery power level is above a power threshold.

11. An apparatus for wireless communication, comprising:
a memory; and
at least one processor coupled to the memory and configured:
to determine a remaining battery power level of a user equipment; and
to set a paging indicator detection threshold based at least in part on the determining and on a function of a standard deviation of a paging indicator channel (PICH) signal strength.

12. The apparatus of claim 11, in which the paging indicator detection threshold is a threshold of received power for a received transmission on a PICH.

13. The apparatus of claim 11, in which the at least one processor is further configured to map remaining battery power levels to PICH detection thresholds to set the paging indicator detection threshold.

14. The apparatus of claim 11, in which the at least one processor is further configured to raise the paging indicator detection threshold when the remaining battery power level is below a power threshold.

15. The apparatus of claim 11, in which the at least one processor is further configured to lower the paging indicator detection threshold when the remaining battery power level is above a power threshold.

16. A computer program product for wireless communications in a wireless network, comprising:
a computer-readable medium having non-transitory program code recorded thereon, the program code comprising:
program code to determine a remaining battery power level of a user equipment; and
program code to set a paging indicator detection threshold based at least in part on the determining and on a function of a standard deviation of a paging indicator channel (PICH) signal strength.

17. The computer program product of claim 16, in which the paging indicator detection threshold is a threshold of received power for a received transmission on a PICH.

18. The computer program product of claim 16, in which the program code further comprises code to map remaining battery power levels to PICH detection thresholds to set the paging indicator detection threshold.

19. The computer program product of claim 16, in which the program code further comprises code to raise the paging indicator detection threshold when the remaining battery power level is below a power threshold.

20. The computer program product of claim 16, in which the program code further comprises code to lower the paging indicator detection threshold when the remaining battery power level is above a power threshold.
